(19) United States
(12) Patent Application Publication
(10) Pub. No.: US 2009/0068551 A1
(43) Pub. Date: Mar. 12, 2009

(54) MOTOR-VEHICLE BATTERY TRAY AND THERMAL PROTECTION BOX FOR A BATTERY PROVIDED WITH SUCH A TRAY

(75) Inventors: Denis Bernard, Voisins-le-Bretonneux (FR); Pedro Carmona, Montigny-le-Bretonneux (FR); Arnaud Roy, Antony (FR); Mathieu Saubion, Montigny-le-bretonneux (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S, BOULOGNE BILLANCOURT (FR)

(21) Appl. No.: 12/281,884

(22) PCT Filed: Feb. 21, 2007
(86) PCT No.: PCT/FR07/50833

§ 371 Date: Oct. 16, 2008

(30) Foreign Application Priority Data
Mar. 6, 2006 (FR) 0601963

(51) Int. Cl. H01M 2/10

(52) U.S. Cl. 429/100

(57) ABSTRACT

A motor-vehicle battery tray configured to accommodate a base of a battery and to be placed on a battery support forming part of the vehicle. The battery tray includes an end wall configured to accommodate the base of the battery, the wall including an internal face configured to accommodate the base of the battery and an external face configured to rest on the battery support, and the internal and external faces each include a plurality of strips extending approximately perpendicular to the end wall. A thermal protection box for a motor-vehicle battery includes a casing, a cover, and the battery tray, the casing being connected to the tray and to the cover so as to form a box, configured to house the battery.

The invention relates to a motor vehicle battery tray and a battery heat protection box provided with such a tray.

Motor vehicle batteries, placed inside the engine compartment, are not protected by any part, which causes their premature wear because of the high temperatures to which they are subjected.

Only a support, usually made of aluminum, on which the battery rests, makes it possible to store the heat produced by the engine and reduce the exposure of the battery to heat. This protection is however inadequate, since the heat energy stored by the support disperses very slowly, which has an unfavorable effect on the service life of the battery.

Furthermore, if the battery is damaged, acid leaks may occur and greatly damage the parts in contact with the battery.

Certain batteries are designed with internal heat exchangers in order to protect them against the heat, as described for example in documents FR 2 867 613, FR 2 768 557, FR 2 779 872, or U.S. Pat. No. 5,569,552. Such batteries comprise double walls or internal fluid circulation circuits so that they are complex and costly to produce. Furthermore, the deterioration of the internal heat exchangers may damage the components of the battery. Finally, in certain cases, cooling devices outside the battery must be provided in certain conditions, which increases the space requirement of the battery.

The object of the invention is to remedy these disadvantages by proposing a battery tray and a battery heat protection box which make it possible to improve the heat protection of the battery and consequently to increase its service life.

Accordingly, the subject of the invention is a motor vehicle battery tray designed to receive the base of the battery and to be placed on a battery support forming part of the vehicle, characterized in that it comprises a bottom wall capable of receiving the battery base, this wall comprising an inner face designed to receive the battery base and an outer face designed to rest on the battery support, and in that the inner face and outer face are each provided with a plurality of slats extending substantially perpendicularly to the bottom wall.

The battery base then rests on the slats of the inner face of the tray, the tray itself resting on the battery support by means of the slats of its outer face. The effect of this arrangement is to produce air circuits between the battery and the tray on the one hand and between the tray and the battery support on the other hand that attenuate the heat originating from the battery support.

The slats also have the advantage of stiffening the tray.

Advantageously, the slats are distributed evenly over at least a portion of the inner and outer faces, which allows a better distribution of the forces sustained by the slats.

Furthermore, if the battery is damaged, it can happen that acid leaks flow from the battery and greatly damage the parts in contact with the battery.

The object of the present invention is also to solve this problem by proposing a tray whose bottom wall is provided with a liquids drain hole opening on the side of the outer face of the wall onto a drain pipe, and the slats of the inner face thereof are arranged so as to form a drainage circuit carrying the liquids to the drain hole.

Thanks to the drain pipe, any acid leaks may therefore flow away from the parts close to the battery without risking damaging them.

Advantageously, the tray is provided with fastening holes designed to receive members for fastening to the battery support, and these fastening holes are placed outside the drainage circuit. Therefore, in the event of acid leaks, the fastening members are not damaged and the battery remains firmly fixed to its support.

Preferably, the tray is made of a polypropylene-based material.

The invention also relates to a heat protection box for a motor vehicle battery, characterized in that it comprises a casing, a cover and a tray according to the invention, the casing being connected to the tray and to the cover so as to form a box capable of housing a battery.

Such a box makes it possible to improve the heat protection of the battery provided by the tray according to the invention and therefore to prolong the service life of the battery.

Advantageously, the dimensions of the casing and of the cover are chosen so as to arrange a space between the battery to be housed and the inner walls of the protection box, this being so in order to provide air circulation all around the battery.

Advantageously, the cover has aeration openings which allow the hot air circulating around the battery inside the box to escape, and prevent the accumulation of hot air around the battery. These openings may also be used for running the battery connection cables.

The invention is now described with reference to the appended drawings which are nonlimiting, in which:

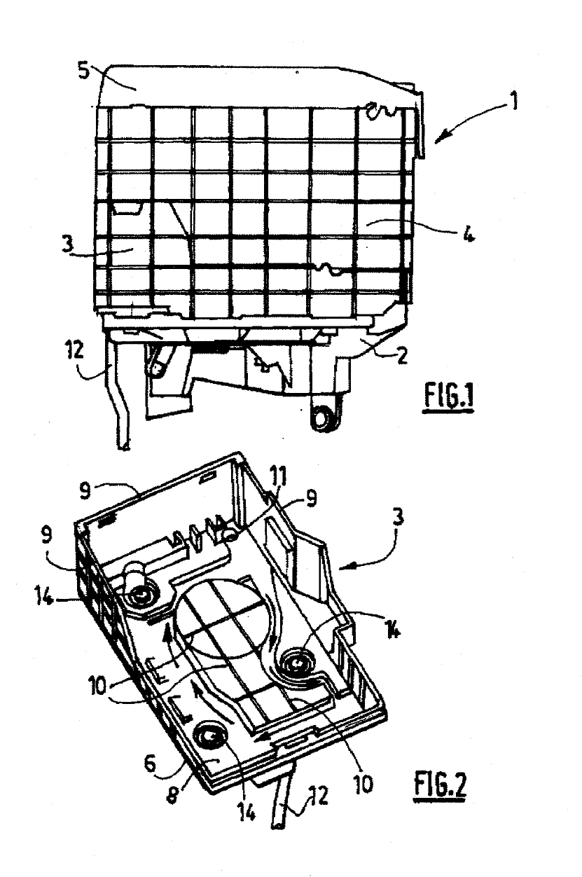

FIG. 1 is a side view of a heat protection box according to the invention;

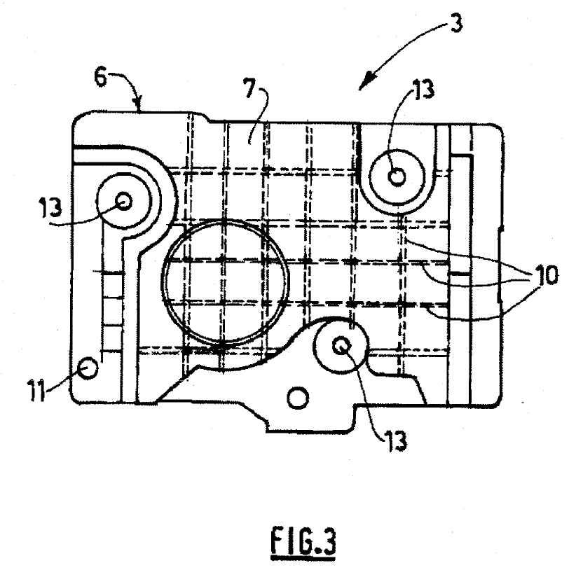

FIG. 2 is a view in perspective of the top of the tray of the box represented in FIG. 1;

FIG. 3 is a view in perspective of the bottom of the tray of the box represented in FIG. 1.

FIG. 1 represents a heat protection box 1 of a battery (not shown) designed to rest on an aluminum support 2 situated in the engine compartment of the vehicle.

The heat protection box 1 comprises a tray 3, a casing 4 and a cover 5. The casing 4 is connected to the tray 3 and to the cover 5 so as to form a closed box capable of housing a battery.

The dimensions of the casing and of the cover are preferably chosen so as to arrange a space between the battery to be housed and the inner walls of the protection box in order to facilitate air circulation.

Preferably, the cover 5 also has aeration openings (not shown) in order to promote the escape of the hot air through the top of the heat protection box 1.

The tray 3 has a bottom wall 6 designed to rest on the battery support 2 on the side of its outer face 7, and to receive the battery on the side of its inner face 8. The tray also comprises side walls 9 to which the casing 4 will be fitted.

According to the invention, the outer face 7 and inner face 8 are each provided with a plurality of slats 10 extending substantially perpendicularly to the bottom wall 6. These slats 10 make it possible to arrange a space between the battery and the tray on the one hand, and the tray and the battery support on the other hand, the battery resting on the free edges of the slats 10 of the inner face 8, and the tray resting on the free edges of the slats 10 of the outer face 7. The presence of the slats also makes it possible to reinforce the structure of the tray which is therefore stronger.

Preferably, the slats 10 extend over at least half of the surface of each face of the bottom wall 6.

Preferably, the height of these slats is chosen so as to allow the creation of an air cushion sufficient to ensure an effective escape of the heat. This height is preferably at least equal to approximately 1.5 mm.

Preferably, the thickness of the slats is chosen so as to ensure a sufficient mechanical strength, the slats 10 of the inner face 8 supporting the weight of the battery, while the slats 10 of the outer face 7 support the weight of the heat protection box and the battery.

In the example shown, the slats 10 are arranged in a grid fashion. They are therefore distributed evenly. Any other even arrangement of the slats may however be adopted (for example a honeycomb configuration).

The bottom wall 6 is also provided with a liquids drain hole 11 opening on the side of the outer face 7 of the bottom wall onto a drain pipe 12.

In addition, the slats 10 of the inner face 8 are arranged so as to form a drainage circuit (symbolized by the arrows shown in FIG. 2) carrying the liquids to the drain hole 11. In the example, this drainage circuit is situated on the periphery of the zone provided with slats 10.

The tray 3 is provided with fastening holes 13 designed to receive members 14 (screws, rivets or similar elements) for fastening to the battery support 2. These fastening holes 13 are placed outside the drainage circuit in order to prevent any corrosion of the fastening members 14 by acid leaks flowing from the battery.

The tray, the cover and the casing are preferably made separately of a molded plastic, for example of a polypropylene-based material, if necessary reinforced. It is therefore possible to use polypropylene containing 30% glass fibers (PP GF 30).

The tray is preferably made in one piece, for example by molding.

The tray, the casing and the cover are each designed so as to be able to be connected to one another. This connection may be achieved by interlocking, by clips or any other appropriate means.

The tray and the box according to the invention have the advantage of being independent of the battery structure. They may therefore accommodate various types of battery. They also have the advantage of being simple and cheap to produce. Furthermore, the casing does not need to fit in a sealed manner to the tray and the cover, so that the production of these parts does not require great precision and is not very costly.

1-8. (canceled)

9: A motor vehicle battery tray configured to receive a base of a battery and to be placed on a battery support forming part of the vehicle, comprising:
a bottom wall configured to receive the battery base, the bottom wall comprising an inner face configured to receive the battery base and an outer face configured to rest on the battery support, and
wherein the inner face and outer face each include a plurality of slats extending substantially perpendicularly to the bottom wall.

10: The battery tray as claimed in claim 9, wherein the slats are distributed evenly over at least a portion of the inner and outer faces.

11: The battery tray as claimed in claim 9, wherein the bottom wall includes a liquids drain hole opening on the side of the outer face of the wall onto a drain pipe, and wherein the slats of the inner face are configured so as to form a drainage circuit carrying the liquids to the drain hole.

12: The battery tray as claimed in claim 11, further comprising fastening holes configured to receive members for fastening to the battery support, and wherein the fastening holes are placed outside the drainage circuit.

13: The battery tray as claimed in claim 9, made of a polypropylene-based material.

14: A heat protection box for a motor vehicle battery, comprising:
a casing;
a cover; and
a tray as claimed in claim 9, the casing being connected to the battery tray and to the cover so as to form a box configured to house the battery.

15: The heat protection box as claimed in claim 14, wherein the casing and the cover form a space between the battery to be housed and the inner walls of the protection box.

16: The heat protection box as claimed in claim 14, wherein the cover includes aeration openings.
